(19) United States
(12) Patent Application Publication
(10) Pub. No.: US 2012/0089515 A1
(43) Pub. Date: Apr. 12, 2012

(54) IDENTIFICATION LEVEL GENERATION METHODS AND SYSTEMS

(75) Inventor: Michael F. Rodin, Ambler, PA (US)

(73) Assignee: The Western Union Company, Englewood, CO (US)

(21) Appl. No.: 12/900,902

(22) Filed: Oct. 8, 2010

(51) Int. Cl. G06Q 40/00

(52) U.S. Cl. 705/44

(57) ABSTRACT

According to the invention, a method for approving financial transactions involving money transfer agents and individuals is disclosed. The method may include receiving a request to conduct a money transfer at a money transfer agent location characterized by a first quality level. The method may include determining that the money transfer requires a minimum agent quality level, and a minimum identification quality level of identification of the individual. The method may include inspecting a form of identification characterized by a second quality level of the requestor. The method may include comparing the first quality level to the minimum agent quality level to verify that the agent location is qualified and the second quality level to the minimum identification quality level to verify that the identification is sufficient. The method may include initiating the money transfer upon verifying that the agent location is qualified and that the identification is sufficient.

### BACKGROUND OF THE INVENTION

This invention relates generally to money transfers. More specifically the invention relates to identification and qualification verification of the money transfer parties (for example, the agent, sender, and receiver) during initiation of money transfers.

In many areas, even where simple person-to-person money transfers are common, barriers remain to conducting more complex and/or riskier transactions. Money transfer consumers may not be able to determine what types or amount of money transfers a given money transfer location can process. Additionally, various types of money transfers may require some confirmation that the initiator is who they say they are. And currently available systems are unable to recognize repeat users of the money transfer systems in a meaningful and significant way for identity verification and/or transaction history analysis.

In addition to the above concerns, there are security concerns regarding the money transfer agent which may conduct one of the above transfers. For example, current money transfer systems may not be aware of either the physical or procedural security measures that a money transfer agent has at its disposal. Physical security measures may include the ability to securely handle a certain amount of cash transfer. Procedural security measures may include the ability to comply with anti-terrorism and anti-money-laundering laws.

Embodiments of the present invention provide solutions to these and other problems.

### BRIEF DESCRIPTION OF THE INVENTION

In one embodiment, a method for approving financial transactions involving money transfer agents and individuals is provided. The method may include receiving, at a money transfer agent location, a request from an individual to conduct a money transfer, where the money transfer agent location is characterized by a first quality level. The method may also include determining that the money transfer requires a minimum agent quality level of the money transfer agent location and a minimum identification quality level of identification of the individual. The method may further include inspecting, at the money transfer agent location, a form of identification provided by the individual, where the form of identification is characterized by a second quality level. The method may additionally include comparing the first quality level to the minimum agent quality level to verify that the agent location is qualified to conduct the money transfer. The method may moreover include comparing the second quality level to the minimum identification quality level to verify that the form of identification is sufficient for the money transfer. The method may furthermore include initiating the money transfer upon at least verifying that the agent location is qualified to conduct the money transfer and that the form of identification is sufficient for the money transfer.

In another embodiment, a system for approving financial transactions involving money transfer agents and individuals is provided. The system may include a computer system in communication with a computer readable medium, where the computer readable medium comprises instructions executable by the computer. The instructions executable by the computer may include instructions for receiving, from a money transfer agent location, a request from an individual to conduct a money transfer, where the money transfer agent location is characterized by a first quality level. The instructions executable by the computer may also include instructions for determining that the money transfer requires a minimum agent quality level of the money transfer agent location, and a minimum identification quality level of identification of the individual. The instructions executable by the computer may further include instructions for receiving, from a money transfer location, verification of inspection of a form of identification provided by the individual, where the form of identification is characterized by a second quality level. The instructions executable by the computer may additionally include instructions for comparing the first quality level to the minimum agent quality level to verify that the agent location is qualified to conduct the money transfer. The instructions executable by the computer may moreover include instructions for comparing the second quality level to the minimum identification quality level to verify that the form of identification is sufficient for the money transfer. The instructions executable by the computer may moreover include instructions for initiating the money transfer upon at least verifying that the agent location is qualified to conduct the money transfer and that the form of identification is sufficient for the money transfer.

In another embodiment, a system for approving financial transactions involving money transfer agents and individuals is provided. The system may include a server. The server may be configured to maintain a first data file comprising data regarding a plurality of money transfer agent locations. The server may also be configured to maintain a second data file comprising data regarding a plurality of individuals. The data regarding the plurality of money transfer agent locations may include an identifier for each money transfer agent location, where the identifier distinguishes each money transfer agent location from other money transfer locations. The data regarding the plurality of money transfer agent locations may also include a certification status for each money transfer agent location, where the certification status identifies a quality level for each money transfer agent location. The data regarding the plurality of individuals may include an identifier for each individual, where the identifier distinguishes each individual from other individuals. The data regarding the plurality of individuals may also include a transaction history for each individual. The server may be further configured to receive a request to initiate a money transfer from a particular money transfer agent location. The request may include a particular identifier and an identification of the a particular individual. The server may be additionally configured to determine the certification status of the particular money transfer agent location based at least in part on the particular identifier. The server may be furthermore configured to access the transaction history of the particular individual based at least in part on the identification. The server may be moreover configured to initiate or not initiate the money transfer based at least in part on at least one characteristics of the money transfer, the determined certification status, and the accessed transaction history.

### BRIEF DESCRIPTION OF THE DRAWINGS

The present invention is described in conjunction with the appended figures:

FIG. 1 is a block diagram of a system of the invention for approving financial transactions involving money transfer agents and individuals;

FIG. 2 is a block diagram of a method of the invention for approving financial transactions involving money transfer agents and individuals; and

FIG. 3 is a block diagram of an exemplary computer system capable of being used in at least some portion of the systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

The term “computer readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In one embodiment of the invention, a method for approving financial transactions involving money transfer agents and individuals is provided.

The method may include receiving, at a money transfer agent location, a request from an individual to conduct a money transfer, where the money transfer agent location is characterized by a first quality level. The first quality level may be determined by an auditing process which in turn determines what type of transfers, both by amount and characteristic, the money transfer agent location is qualified to handle or accept requests and currency for. This may derive from the money transfer agent location's ability to conform with various government and money transfer company regulations, for example, anti-terrorist and anti-money laundering laws and codes.

The request to conduct a money transfer may be, merely by way of example, a request to conduct a money transfer that completes, from the individual to the recipient, a bill payment, a payment for services or goods, or a person-to-person transfer. This may be referred to herein as the “type” of money transfer. By comparison to a database, the method may also include determining if the recipient is a known payee, an unknown payee, a low risk payee, and/or high risk payee. This may influence the categorization of the money transfer into a certain type. For example, a requested money transfer may, in totality of type, be a person-to-person transfer to a high risk payee, or in another example be a bill payment to a known low risk payee. Additionally, a money transfer may include a cash or non-cash transfer. For example, non-cash transfers of virtual money or goods, redeemable tokens, or cash credit may also be conducted by embodiments of the instant invention. Furthermore, in some embodiments of the invention, money transfers may be limited to consumer-oriented money transfers where money is not necessarily transferred from one location to another to pay a recipient, or accounted for via an inter-institutional clearing-house, but rather a recipient is paid by the service provider based primarily on receipt by the service provider of the amount from the sender and proper accounting and verification of such.

The method may also include determining that the money transfer requires a minimum agent quality level of the money transfer agent location and a minimum identification quality level of identification of the individual. A money transfer agent may be any person authorized to initiate money transfer transactions in the host system operated by the financial service provider. In this manner, different types of transfers may have tiered requirements for the agent quality level and identification quality level of identification of the individual. In each case, for the agent and for the individual, the quality level may be adjusted based on a transaction history associated with the either party. This may be referred to as an “adjusted” quality level.

Note that the money transfer agent “location” may not be a static physical location, but may merely be representative of the particular agent conducting a transaction. In this manner, agents may employ mobile devices or systems which are capable of initiating transactions wherever the devices or systems can connect to a larger network to communicate with necessary systems to conduct a money transfer. In such embodiments, the agent quality level can be determined based on the experience or transaction history of the agent, as well as determinations based on an examination of their procedures and capabilities. Additionally, the instant location of the agent's mobile device or system can be determined via GPS or other means (i.e. cellular communication network location identification), and such location used to adjust the agent's present quality level. For example, if the device or system being used by the agent is in an unusual location, the instantaneous quality level of the agent can be downgraded to limit exposure to riskier transactions until the agent is in a more normal operating geography.

The method may further include inspecting, at the money transfer agent location, a form of identification provided by the individual, where the form of identification is characterized by a second quality level. Merely by way of example, the for of identification may be a local, state, regional, national, or internationally issued form of identification, with or without picture. Some examples include a private company identification badge, a library card, drivers license, social security card, and/or passport. These forms of identification may differ in their reliability, and hence quality level. Another form of identification may be self identification, where the individual merely alleges that they are a particular person. In some embodiments, this may be the weakest form of identification.

In these or other embodiments, the individual may also, after initially providing a form of identification, also provide biometric information such as a fingerprint, physical image of the individual (i.e. face), DNA, palm print, hand geometry information, iris or retina information, etc. which may be correlated with the form of identification and/or the information thereon. This correlated information may be stored at a central repository for later use in verifying the identity of the individual with only provision by the individual of the biometric information for identity confirmation. Therefore, the strength of the biometric information used to identify an individual can thereafter be related to the strength of the originally provided identification form to verify the identity of a sender or receiver.

The method may additionally include comparing the first quality level to the minimum agent quality level to verify that the agent location is qualified to conduct the money transfer. The method may moreover include comparing the second quality level to the minimum identification quality level to verify that the form of identification is sufficient for the money transfer.

The method may furthermore include initiating the money transfer upon at least verifying that the agent location is qualified to conduct the money transfer and that the form of identification is sufficient for the money transfer.

In some embodiments, at least one of the minimum agent quality level and the minimum identification quality level may be based at least in part on a total value of the money transfer. In these or other embodiments, at least one of the minimum agent quality level and the minimum identification quality level may also be based at least in part on a type of the money transfer.

As discussed above, in some embodiments at least one of the minimum agent quality level and the minimum identification quality level may be based at least in part on a transaction history of the individual, a transaction history of the money transfer agent location; and/or a transaction history of a recipient of the money transfer.

In some embodiments, the recipient of the money transfer may refer to one or more entities. Merely by way of example, the recipient may be a financial institution, an account at the financial institution, and/or a beneficiary of the account at the financial institution. In yet other embodiments, the accounts of a recipient may not be held at financial institutions. Merely by way of example, stored value accounts, or other types of accounts, held with a merchant or service provider, could be credited on behalf of a recipient.

In some embodiments, the request from the individual to conduct the money transfer may include the specification by the individual of a pick-up location for a recipient of the money transfer. In these or other embodiments, the method may also include verifying that the pick-up location of the money transfer (where the recipient will collect the money transfer) is capable of funding the money transfer upon demand by recipient. In such embodiments, the method may include initiating the money transfer upon at least verifying that the pick-up location is capable of funding the money transfer upon demand by recipient.

While different embodiments may have different possible spectrums of acceptable quality levels, both discrete or continuous, in some embodiments both the first quality level and the second quality level may be defined by three minimum thresholds. Merely by way of example the quality levels may be defined by a possible first threshold, a possible second threshold level greater than the first threshold level, and a possible third threshold level greater than the second threshold level. Merely by way of example on the money transfer agent location side, money transfer agent locations may be categorized as bronze, silver, or gold level locations, reflective of three different and ascending quality levels. These ascending quality levels indicate an ability to process/initiate more and more complex and/or high risk transactions. Money transfer agent locations may advertise such quality levels to inform consumers of their ability to initiate varying levels of transactions. Individuals wishing to initiate transactions, and/or recipients of transactions, may also be defined by such tri-level schemes.

To further supplement either the qualification of the money transfer agent location and/or the individuals/entities both initiating and receiving money transfers, details regarding money transfers involving such parties may be recorded for reference and analysis. Reference and analysis of such transaction history may influence the quality level of each such party. Additional information may be supplied to the system such that particular transactions in transaction history can be flagged as fraudulent/improper/illegal after the fact, and thereby affect the quality level of the relevant parties.

In another embodiment of the invention, a system for approving financial transactions involving money transfer agents and individuals is provided. The system may include a computer system in communication with a computer readable medium, where the computer readable medium comprises instructions executable by the computer. The instructions executable by the computer may include instructions for receiving, from a money transfer agent location, a request from an individual to conduct a money transfer, where the money transfer agent location is characterized by a first quality level. The instructions executable by the computer may also include instructions for determining that the money transfer requires a minimum agent quality level of the money transfer agent location, and a minimum identification quality level of identification of the individual. The instructions executable by the computer may further include instructions for receiving, from a money transfer location, verification of inspection of a form of identification provided by the individual, where the form of identification is characterized by a second quality level. The instructions executable by the computer may additionally include instructions for comparing the first quality level to the minimum agent quality level to verify that the agent location is qualified to conduct the money transfer. The instructions executable by the computer may moreover include instructions for comparing the second quality level to the minimum identification quality level to verify that the form of identification is sufficient for the money transfer. The instructions executable by the computer may moreover include instructions for initiating the money transfer upon at least verifying that the agent location is qualified to conduct the money transfer and that the form of identification is sufficient for the money transfer.

In another embodiment of the invention, a system for approving financial transactions involving money transfer agents and individuals is provided. The system may include a server. The server may be configured to maintain a first data file comprising data regarding a plurality of money transfer agent locations. The server may also be configured to maintain a second data file comprising data regarding a plurality of individuals. The data regarding the plurality of money transfer agent locations may include an identifier for each money transfer agent location, where the identifier distinguishes each money transfer agent location from other money transfer locations. The data regarding the plurality of money transfer agent locations may also include a certification status for each money transfer agent location, where the certification status identifies a quality level for each money transfer agent location. The data regarding the plurality of individuals may include an identifier for each individual, where the identifier distinguishes each individual from other individuals. The data regarding the plurality of individuals may also include a transaction history for each individual. The server may be further configured to receive a request to initiate a money transfer from a particular money transfer agent location. The request may include a particular identifier and an identification of the a particular individual. The server may be additionally configured to determine the certification status of the particular money transfer agent location based at least in part on the particular identifier. The server may be furthermore configured to access the transaction history of the particular individual based at least in part on the identification. The server may be moreover configured to initiate or not initiate the money transfer based at least in part on at least one characteristics of the money transfer, the determined certification status, and the accessed transaction history.

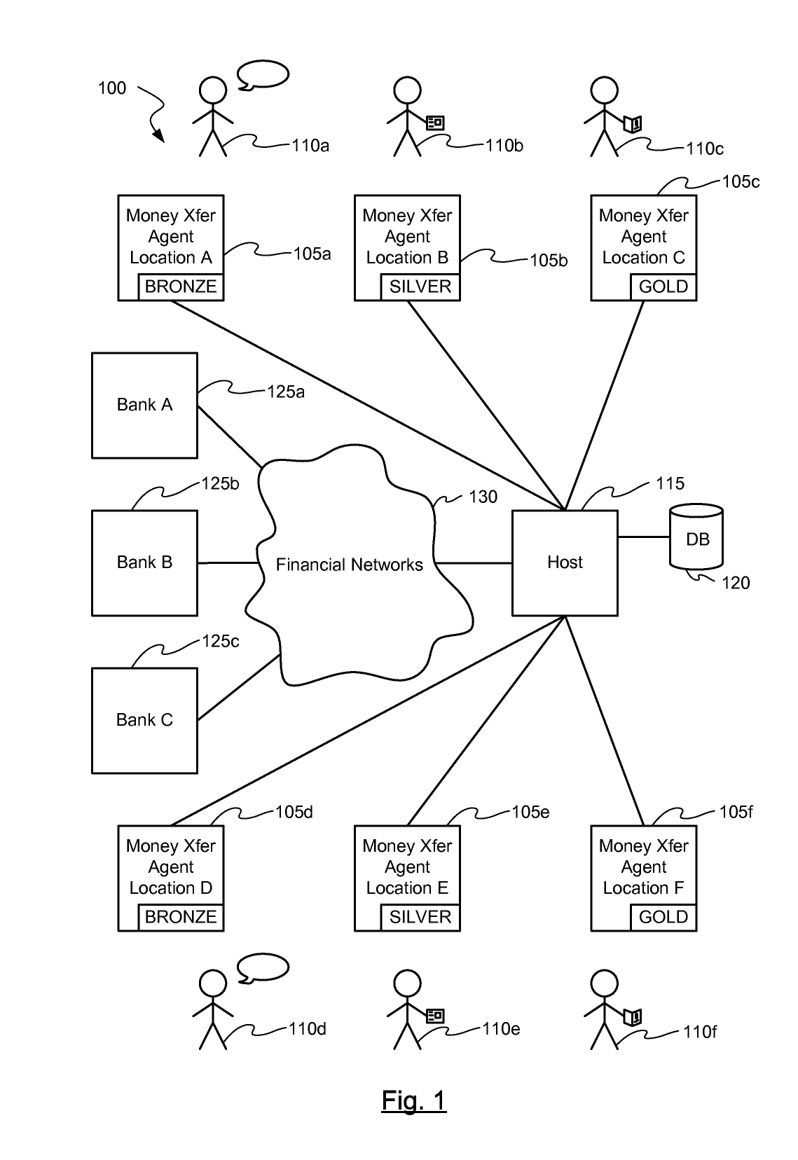

Turning now to FIG. 1, a block diagram of a system 100 of the invention for approving financial transactions involving money transfer agent locations 105 and individuals 110 is shown.

Different money transfer agent locations 105 may be rated at different quality levels. As shown in this example, money transfer agent locations 105a, 105d are bronze rated locations. In this exemplary embodiment, bronze money transfer locations 105 may be certified to handle only small person-to-person money transfers and simple bill payments to well known payees that have significant transaction history. A host 115 having a storage database 120 may store this relationship information.

Money transfer agent locations 105b, 105e are silver rated locations. In this exemplary embodiment, silver money transfer locations 105 may be certified to handle only medium sized person-to-person money transfers and bill payments to less well known payees that may have minimal transaction history. Money transfer agent locations 105c, 105f are gold rated locations. In this exemplary embodiment, gold money transfer locations 105 may be certified to handle only even large sized person-to-person money transfers and bill payments to as-of-yet unknown payees that may have minimal or no transaction history.

Each of individuals 110 may be able to establish their identity through different means. In this example, individuals 110a, 110d may only be able to verbally (or similarly) assert their identities, individuals 110b, 110e may have some simple form of identification such as a government issued identification card, and individuals 110c, 110f may have an identification source that is very reliable such as a passport. These identification forms may be verified at money transfer agent locations 105 either manually (possibly by agents) or by an automatic system at those locations. This information may be transmitted to host 115 thereafter, possibly as part of the money transfer request.

Each of individuals 110 may desire to request that the money transfer company operating host 115 and money transfer locations 105 initiate a money transfer. As discussed above, these money transfers may be of different types and amounts. Depending on the type and amount, sender and/or receiver money transfer agent location 105 (or point-of-sale devices and computers at those locations), and prior transaction history of sender and/or receiver, may determine if the individual 110 is allowed to initiate such a transfer.

Additionally, a transaction history of the individual 110 wishing to make the transfer, may be stored at host 115 and/or money transfer agent location 105 (or point-of-sale devices and computers at those locations). This transaction history may include transactions requested and/or initiated in the past at any or all of the money transfer agent locations 105. The transaction history may inform the reliability and thus the quality of the identification produced by individual 110 and result in an increased adjusted quality level for the individual's 110 identification form. Likewise, transaction histories stored for the recipient and the particular money transfer agent location initiating the transfer for individual 110 may inform their respective quality levels, making a requested money transfer more or less likely to be initiated by host 115.

FIG. 1 also shows potential recipients of the money transfer initiated by individual 110. For example, any of the individuals 110 may also be recipients, or banks 125 may also receive money transfers via financial networks 130. Entities and or individuals 110 may also be true recipients of money transfers when their accounts at banks 125 are credited from such transfers. Additionally, host 115 and/or money transfer agent location 105 (or point-of-sale devices and computers at those locations) may determine, possibly prior to initiating the money transfer, whether a recipient pick-up location (for example, bank 125 and/or money transfer agent location 105) will be able to fund the money transfer when the recipient makes a demand on the funds.

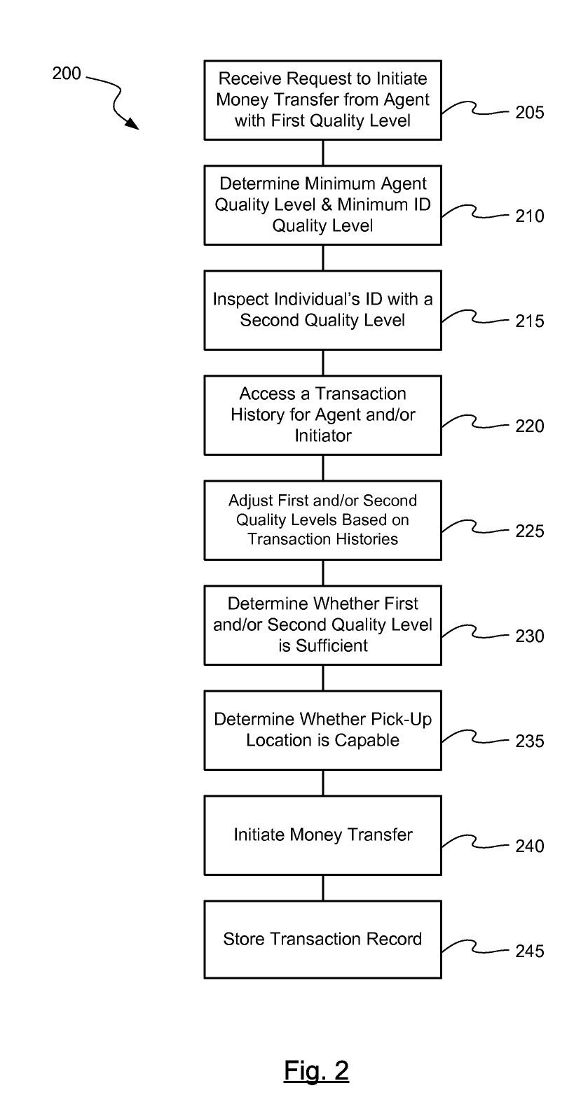

FIG. 2 shows a block diagram of a method 200 of the invention for approving financial transactions involving money transfer agents and individuals. At block 205, a request to initiate a money transfer may be received at a server from an agent having a first quality level.

At block 210, the server may determine a minimum agent quality level and minimum identification quality level required fro the transaction based on at least some of the characteristics of the requested money transfer. At block 215, an agent may inspect the identification form presented by the money transfer requestor. Information related to the identification may then be forwarded from the agent to the server.

At block 220, the server may access a transaction history for the agent and/or the initiator. In some embodiments, the server may also access a transaction history for the recipient of the money transfer. At block 225, the server may adjust the required quality levels for the money transfer agent location and/or the initiator based on the transaction histories. In some embodiments, these required quality levels may further be adjusted based at least in part on a transaction history of the recipient.

At block 230, the server, or a money transfer agent location, may determine whether the first and/or second quality level provide sufficient basis to initiate the money transfer based on the above described factors. At block 235, the server may also determine whether a pick-up location (if specified by the money transfer request (person-to-person transfers)) is capable of servicing the money transfer request.

At block 240, the money transfer is initiated if approved in the above steps. At block 245, a transaction record regarding the money transfer, successful or not, may be stored for future access in repeating the process for additional money transfers.

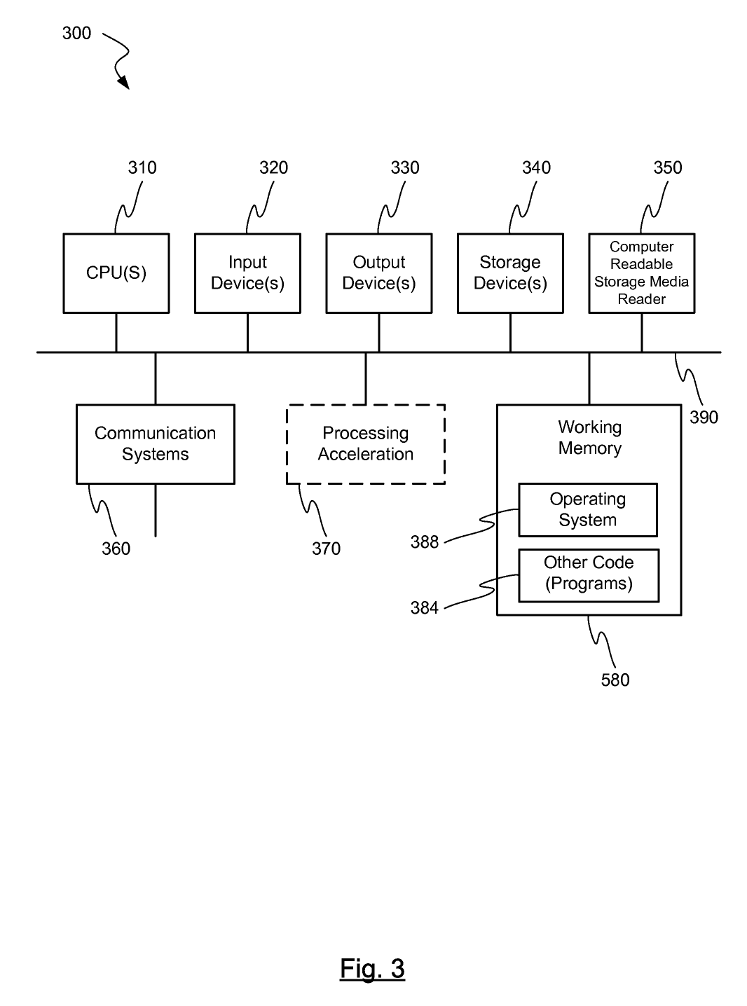

FIG. 3 is a block diagram illustrating an exemplary computer system 300 in which embodiments of the present invention may be implemented. This example illustrates a computer system 300 such as may be used, in whole, in part, or with various modifications, to provide the functions of the money transfer agent location 105 or point-of-sale device there, the computer system, host 115, database 120, financial network 130, bank 125 system, and/or other components of the invention such as those discussed above. For example, various functions of host 115 may be controlled by the computer system 300, including, merely by way of example, comparing quality levels, initiating money transfers, conducting money transfers, evaluating identification forms, etc.

The computer system 300 is shown comprising hardware elements that may be electrically coupled via a bus 390. The hardware elements may include one or more central processing units 310, one or more input devices 320 (e.g., a mouse, a keyboard, etc.), and one or more output devices 330 (e.g., a display device, a printer, etc.). The computer system 300 may also include one or more storage device 340. By way of example, storage device(s) 340 may be disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 350, a communications system 360 (e.g., a modem, a network card (wireless or wired), an infra-red communication device, Bluetooth™ device, cellular communication device, etc.), and working memory 380, which may include RAM and ROM devices as described above. In some embodiments, the computer system 300 may also include a processing acceleration unit 370, which can include a digital signal processor, a special-purpose processor and/or the like.

The computer-readable storage media reader 350 can further be connected to a computer-readable storage medium, together (and, optionally, in combination with storage device(s) 340) comprehensively representing remote, local, fixed, and/or removable storage devices plus storage media for temporarily and/or more permanently containing computer-readable information. The communications system 360 may permit data to be exchanged with a network, system, computer and/or other component described above.

The computer system 300 may also comprise software elements, shown as being currently located within a working memory 380, including an operating system 384 and/or other code 388. It should be appreciated that alternate embodiments of a computer system 300 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 300 may include code 388 for implementing any or all of the function of the various elements of the architecture as described herein. For example, software, stored on and/or executed by a computer system such as system 300, can provide the functions of the money transfer agent location 105 or point-of-sale device there, the computer system, host 115, database 120, financial network 130, bank 125 system, and/or other components of the invention such as those discussed above. Methods implementable by software on some of these components have been discussed above in more detail.

The invention has now been described in detail for the purposes of clarity and understanding. However, it will be appreciated that certain changes and modifications may be practiced within the scope of the appended claims.

What is claimed is:

1. A method for approving financial transactions involving money transfer agents and individuals, wherein the method comprises:
receiving, at a money transfer agent location, a request from an individual to conduct a money transfer, wherein the money transfer agent location is characterized by a first quality level;
determining that the money transfer requires:
a minimum agent quality level of the money transfer agent location; and
a minimum identification quality level of identification of the individual;
inspecting, at the money transfer agent location, a form of identification provided by the individual, wherein the form of identification is characterized by a second quality level;
comparing the first quality level to the minimum agent quality level to verify that the agent location is qualified to conduct the money transfer;
comparing the second quality level to the minimum identification quality level to verify that the form of identification is sufficient for the money transfer; and
initiating the money transfer upon at least verifying that the agent location is qualified to conduct the money transfer and that the form of identification is sufficient for the money transfer.

2. The method for approving financial transactions involving money transfer agents and individuals of claim 1, wherein at least one of the minimum agent quality level and the minimum identification quality level is based at least in part on a total value of the money transfer.

3. The method for approving financial transactions involving money transfer agents and individuals of claim 1, wherein at least one of the minimum agent quality level and the minimum identification quality level is based at least in part on a type of the money transfer.

4. The method for approving financial transactions involving money transfer agents and individuals of claim 3, wherein the type comprises a selection from a group consisting of:
a bill payment to a known payee;
a bill payment to an unknown payee;
a bill payment to a low risk payee;
a bill payment to a high risk payee;
a person-to-person money transfer to a known payee; and
a person-to-person money transfer to an unknown payee.

5. The method for approving financial transactions involving money transfer agents and individuals of claim 1, wherein at least one of the minimum agent quality level and the minimum identification quality level is based at least in part on a transaction history of the individual.

6. The method for approving financial transactions involving money transfer agents and individuals of claim 1, wherein at least one of the minimum agent quality level and the minimum identification quality level is based at least in part on a transaction history of the money transfer agent location.

7. The method for approving financial transactions involving money transfer agents and individuals of claim 1, wherein at least one of the minimum agent quality level and the minimum identification quality level is based at least in part on a transaction history of a recipient of the money transfer.

8. The method for approving financial transactions involving money transfer agents and individuals of claim 7, wherein the recipient comprises:
a person;
a non-financial institution;
a merchant;
a service provider;
a stored-value account;
a financial institution;
an account at the financial institution; or
a beneficiary of the account at the financial institution.

9. The method for approving financial transactions involving money transfer agents and individuals of claim 1, wherein the request from the individual to conduct the money transfer comprises a pick-up location for a recipient, and wherein the method further comprises:
verifying the pick-up location is capable of funding the money transfer upon demand by recipient; and
initiating the money transfer upon at least verifying that the pick-up location is capable of funding the money transfer upon demand by recipient.

10. The method for approving financial transactions involving money transfer agents and individuals of claim 1, wherein each of the first quality level and the second quality level comprises a selection from a group consisting of:
a first threshold;
a second threshold greater than the first threshold; and
a third threshold greater than the second threshold.

11. The method for approving financial transactions involving money transfer agents and individuals of claim 1, wherein the method further comprises recording details regarding the money transfer in relation to the individual as part of a transaction history for the individual.

12. The method for approving financial transactions involving money transfer agents and individuals of claim 1, wherein the method further comprises recording details regarding the money transfer in relation to the money transfer agent location as part of a transaction history for the money transfer agent location.

13. The method for approving financial transactions involving money transfer agents and individuals of claim 1, wherein the method further comprises recording details regarding the money transfer in relation to a recipient of the money transfer as part of a transaction history for the recipient.

14. A system for approving financial transactions involving money transfer agents and individuals, wherein the system comprises:
a computer system in communication with a computer readable medium, wherein the computer readable medium comprises instructions executable by the computer for:
receiving, from a money transfer agent location, a request from an individual to conduct a money transfer, wherein the money transfer agent location is characterized by a first quality level;
determining that the money transfer requires:
a minimum agent quality level of the money transfer agent location; and
a minimum identification quality level of identification of the individual;
receiving, from a money transfer location, verification of inspection of a form of identification provided by the individual, wherein the form of identification is characterized by a second quality level;
comparing the first quality level to the minimum agent quality level to verify that the agent location is qualified to conduct the money transfer;
comparing the second quality level to the minimum identification quality level to verify that the form of identification is sufficient for the money transfer; and
initiating the money transfer upon at least verifying that the agent location is qualified to conduct the money transfer and that the form of identification is sufficient for the money transfer.

15. The system for approving financial transactions involving money transfer agents and individuals of claim 14, wherein at least one of the minimum agent quality level and the minimum identification quality level is based at least in part on a total value of the money transfer.

16. The system for approving financial transactions involving money transfer agents and individuals of claim 14, wherein at least one of the minimum agent quality level and the minimum identification quality level is based at least in part on a type of the money transfer.

17. The system for approving financial transactions involving money transfer agents and individuals of claim 14, wherein at least one of the minimum agent quality level and the minimum identification quality level is based at least in part on a transaction history of the individual.

18. The system for approving financial transactions involving money transfer agents and individuals of claim 14, wherein at least one of the minimum agent quality level and the minimum identification quality level is based at least in part on a transaction history of the money transfer agent location.

19. The system for approving financial transactions involving money transfer agents and individuals of claim 14, wherein the first quality level is a selection from a group consisting of:
a bronze level;
a silver level greater than the bronze level; and
a gold level greater than the silver level.

20. A system for approving financial transactions involving money transfer agents and individuals, wherein the system comprises:
a server, wherein:
the server is configured to maintain a first data file comprising data regarding a plurality of money transfer agent locations;
the server is configured to maintain a second data file comprising data regarding a plurality of individuals;
the data regarding the plurality of money transfer agent locations comprises:
an identifier for each money transfer agent location, wherein the identifier distinguishes each money transfer agent location from other money transfer locations; and
a certification status for each money transfer agent location, wherein the certification status identifies a quality level for each money transfer agent location;
the data regarding the plurality of individuals comprises:
an identifier for each individual, wherein the identifier distinguishes each individual from other individuals; and
a transaction history for each individual;
the server is configured to receive a request to initiate a money transfer from a particular money transfer agent location, wherein the request comprises:
a particular identifier;
an identification of the a particular individual;
the server is configured to determine the certification status of the particular money transfer agent location based at least in part on the particular identifier;
the server is configured to access the transaction history of the particular individual based at least in part on the identification; and
the server is configured to initiate or not initiate the money transfer based at least in part on:
at least one characteristics of the money transfer;
the determined certification status; and
the accessed transaction history.
